(19) United States
(12) Patent Application Publication
(10) Pub. No.: US 2015/0096644 A1
(43) Pub. Date: Apr. 9, 2015

(54) OIL POURER WITH MOVABLE FUNNEL SECTION

(71) Applicant: Helen of Troy Limited, Belleville (BB)

(72) Inventors: Alex Lee, New York, NY (US); Mackenzie Mor, New York, NY (US); Thomas Jason Dooley, Hoboken, NJ (US); Paul Lacotta, Tenafly, NJ (US); Dio Climaco Cavero, North Merrick, NY (US)

(73) Assignee: Helen of Troy Limited, Belleville (BB)

(21) Appl. No.: 14/048,727

(22) Filed: Oct. 8, 2013

(51) Int. Cl. B67C 11/02

(52) U.S. Cl. CPC B67C 11/02
USPC 141/1; 141/337

(57) ABSTRACT

An oil pourer includes a spout shell that is configured to be connected with a bottle of culinary oil and a collapsible funnel section connected with the spout shell and moveable with respect to the spout shell between an open position and a closed position. When the funnel section is in the open position, the funnel section and the spout shell define an oil-filling opening. When the funnel section is in the closed position, the funnel section seals against the spout shell to close the oil-filling opening. A method of using an oil pourer is also disclosed.

### BACKGROUND

Cooks often transfer culinary oil, e.g., olive oil, from a larger bottle or container into a smaller bottle. The smaller bottle often is easier to handle, which makes it is easier to dispense a desired amount of culinary oil.

Transferring the oil from the larger bottle to the smaller bottle can present problems. First, the spout needs to be removed from the smaller bottle. Also, the mouth of the smaller bottle may be too small to pour oil from the larger bottle into the smaller bottle. Traditional kitchen funnels can be inserted into the mouth of the smaller bottle; however, after use the funnel needs to be cleaned and the spout of the smaller bottle needs to be inserted back into the mouth that was once occupied by the funnel.

### SUMMARY

An example of an oil pourer that can overcome at least one of the aforementioned shortcomings includes a spout shell that is configured to be connected with an associated bottle of culinary oil and a collapsible funnel section connected with the spout shell. The funnel section is moveable with respect to the spout shell between an open position and a closed position. When the funnel section is in the open position, the funnel section and the spout shell define an oil-filling opening. When the funnel section is in the closed position, the funnel section seals against the spout shell to close the oil-filling opening. Also, when the funnel section is in the closed position, the funnel section is positioned to direct oil toward an oil-dispensing opening when the oil pourer is tilted to pour culinary oil from the associated bottle through the oil pourer.

A method of using an oil pourer is also disclosed, which includes connecting an oil pourer to a bottle of culinary oil. The method further includes positioning a collapsible funnel section of the oil pourer in an open position. When in the open position, the funnel section and a spout shell connected with the funnel section define an oil-filling opening. The method further includes pouring culinary oil from a container into the bottle through the oil-filling opening and the oil pourer with the funnel section in the open position. The method further includes positioning the collapsible funnel section of the oil pourer in a closed position. When in the closed position, the funnel section seals against the spout shell to close the oil-filling opening. The method further includes pouring culinary oil from the bottle through the oil pourer and out an oil-dispensing opening with the funnel section in the closed position.

Another example of an oil pourer includes a spout shell and a collapsible funnel section. The spout shell at least partially defines an oil outlet passage, an oil inlet passage, and a hole connecting the oil outlet passage and the oil inlet passage. The spout shell is configured to be connected with an associated bottle of culinary oil. The collapsible funnel section connects with the spout shell and is movable with respect to the spout shell between an open position and a closed position. When the funnel section is in the open position, the funnel section is spaced from a shell inner surface. When the funnel section is in the closed position, the funnel section contacts the shell inner surface and covers the hole.

### BRIEF DESCRIPTION OF THE DRAWINGS

FIG. 1 is a perspective view of an oil pourer having a collapsible funnel section shown in an open position.

FIG. 2 is a cross-sectional view of the oil pourer with the collapsible funnel section in the open position.

FIG. 3 shows the oil pourer connected with a bottle of culinary oil with the collapsible funnel section shown in the closed position.

### DETAILED DESCRIPTION

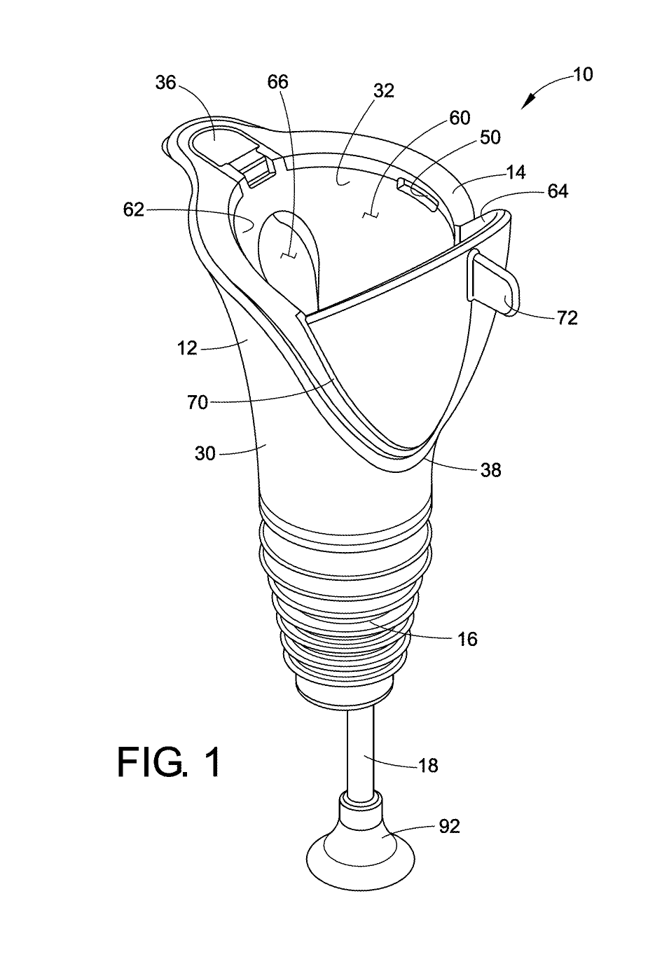

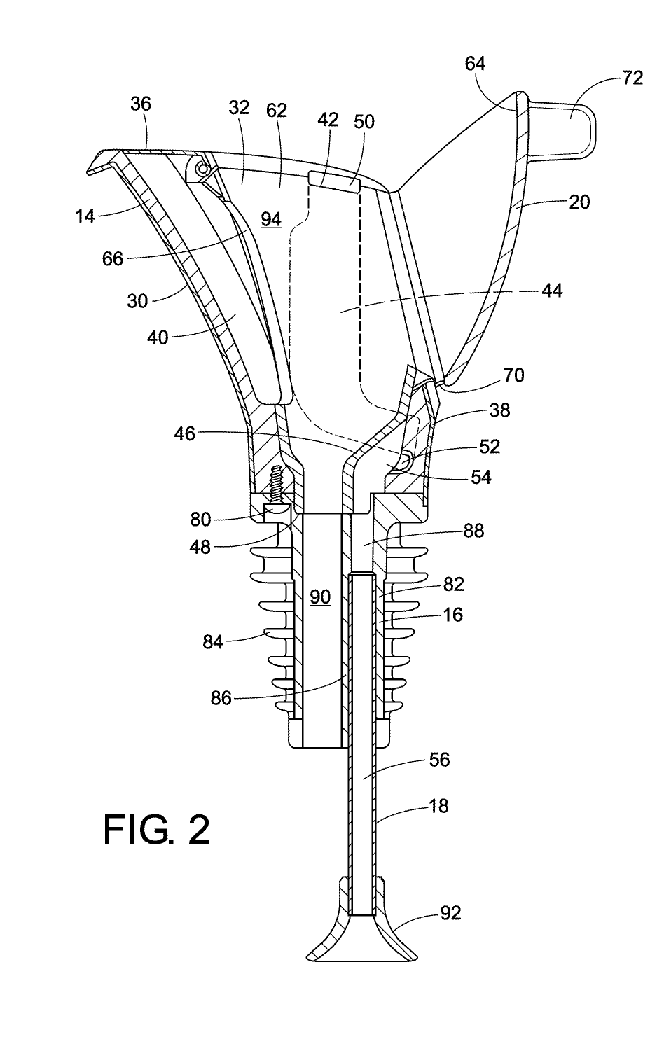

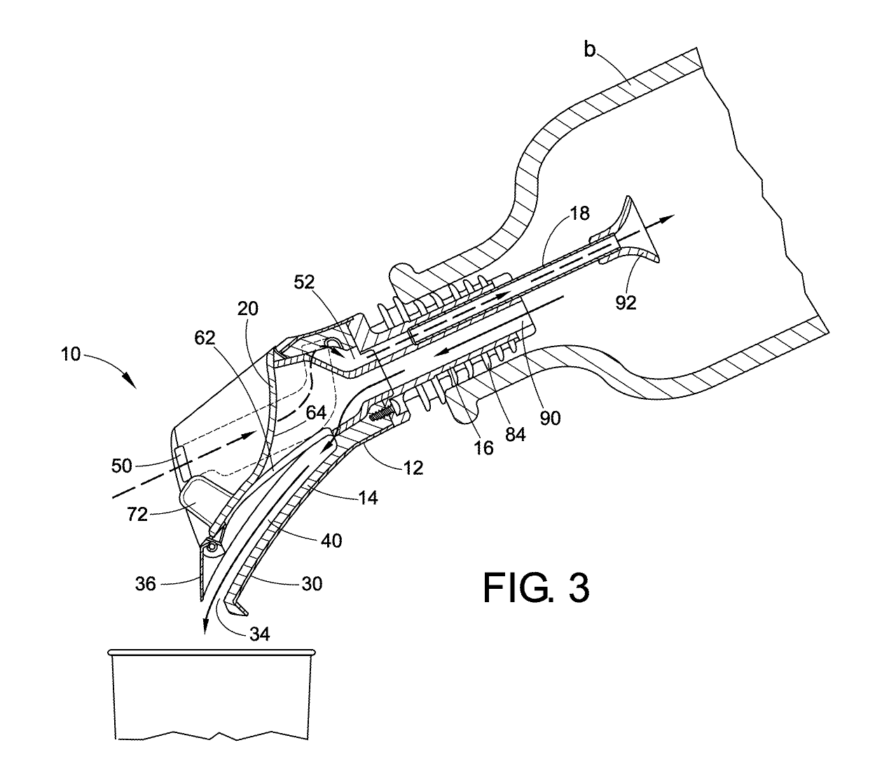

Referring to FIG. 1, an oil pourer 10 includes a spout shell 12, a flexible membrane 14, a bottle insert 16, and a tube 18. In the illustrated embodiment, the flexible membrane 14 includes an integrally formed collapsible funnel section 20 that is moveable with respect to the spout shell 12 between an open position (shown in FIGS. 1 and 2) and a closed position (shown in FIG. 3). The oil pourer 10 can facilitate the transfer of culinary oil from a larger bottle into a smaller bottle and also operate as a spout for the bottle to which it is attached. The collapsible funnel section 20 of the oil pourer 10 can be disposed in the open position and operate similar to a traditional funnel to allow culinary oil to be poured through the oil pourer 10 and into a smaller bottle in which the bottle insert 16 is inserted. The collapsible funnel section 20 can then be moved to the closed position, which is shown in FIG. 3, so that culinary oil can be dispensed from the smaller bottle b onto food, a cooking pan, or the like.

The spout shell 12 is configured to be connected with a bottle b (FIG. 3) of culinary oil. In the illustrated embodiment, the spout shell 12 connects with the bottle b by inserting the bottle insert 16, which is connected with the spout shell 12, into the mouth of the bottle. The spout shell 12 includes an outer shell 30 and an inner shell 32. The outer shell 30 is connected with the inner shell 32, and in the illustrated embodiment, at least a portion of the flexible membrane 14 is disposed between the inner shell 32 and the outer shell 30. The spout shell 12 defines an oil dispensing opening 34 (FIG. 3) through which culinary oil is dispensed from the oil pourer. The oil dispensing opening 34 is covered by a pivoting dust guard 36, which is connected with the inner shell 32. The spout shell 12 also includes a substantially U-shaped edge 38, which is on a side of the spout shell 12 opposite the oil dispensing opening 34.

The outer shell 30 can be made from metal. On a side of the outer shell 30 opposite the U-shaped edge 38 the outer shell bulges outwardly so that the spout shell 12 defines an oil outlet passage 40 that terminates at the oil dispensing opening 34. The inner shell 32 can be similar in shape and configuration to the outer shell 30, while being slightly smaller in size so that the inner shell is received within the outer shell. In the illustrated embodiment, the inner shell 32 is formed of a rigid plastic material.

With reference to FIG. 2, the inner shell 32 includes a notch 42 that spaces the inner shell 32 from the flexible membrane 14 in the area of the notch. A recessed channel 44, which is shown in phantom in FIG. 2, extends downwardly (per the orientation shown in FIG. 2) towards the bottle insert 16 and then bends underneath the U-shaped edge 38. The recessed channel 44 can be formed in the inner shell 32 or the flexible membrane 14 between the inner shell 32 and the flexible membrane 14. The inner shell 32 includes a curved inner wall 46 that extends upwardly from a lower edge 48 of the inner shell 32 toward the recessed channel 42. The spout shell 12 includes an air vent opening 50 that is at least partially defined by the notch 42. The air vent opening 50 is in communication with an air vent passage 52, which is defined by the recessed channel 44 and the internal passage 54 defined by the curved inner wall 46. The air vent passage 52 is further defined by an internal passage 56 of the tube 18 and operates in a manner that will be described in more detail below.

The flexible membrane 14 is made from a silicone material in the illustrated embodiment. Although other materials may be employed, the flexible silicone material allows the funnel section 20 to move between an open and closed position. When the funnel section 20 is in the open position, the funnel section 20 and the spout shell 12 define an oil filling opening 60. The spout shell 12 includes a shell inner surface 62, which is an inner surface of the inner shell 32 in the illustrated embodiment. The funnel section 20 also includes a funnel section inner surface 64. The shell inner surface 62 is concave. The funnel section inner surface 64 is concave when the funnel section 20 is in the open position (FIGS. 1 and 2). This provides a large oil filling opening 60 that facilitates transferring culinary oil from a larger bottle into the smaller bottle b fitted with the oil pourer 10. The funnel section inner surface 64 is convex when in the closed position (see FIG. 3).

When the funnel section 20 is in the closed position, the funnel section 20 seals against the spout shell 12 to close the oil filling opening 60. When the funnel section 20 is in the closed position, the funnel section 20 is also positioned to direct oil toward the oil dispensing opening 34 when the oil pourer 10 is tilted to pour culinary oil from the bottle b through the oil pourer.

The inner shell 32 separates the oil filling opening 60 from the oil dispensing opening 34. The inner shell 34 includes a hole 66 that leads to the oil outlet passage 40 in the spout shell 12. As seen in FIG. 3, the funnel section 20 seals against the spout shell 12, and more particularly against the spout shell inner surface 52 adjacent to the hole 66, when the funnel section 20 is in the closed position.

The funnel section 20 includes a hinge section 70 adjacent the U-shaped edge 38 of the spout shell 12. As mentioned above, the funnel section 20 is integrally formed with the flexible membrane 14, and the flexible membrane 14 is interposed between the inner shell 32 and the outer shell 30. The hinge section 70 can be formed in the flexible membrane 14 and follows the contour of the shaped edge 38 of the spout shell 12. The hinge section 70 has a reduced thickness as compared to an adjacent portion of the funnel section 20 and the flexible membrane 14. The funnel section 20 folds about the hinge section 70 when moving from the open position toward the closed position, and vice versa. The funnel section 20 also includes an outwardly extending tab 72. The tab 72 can be gripped by the operator, for example to pull the tab to move the funnel section 20 from the closed position toward the open position.

The bottle insert 16 connects with the spout shell 12 using fasteners 80. The bottle insert 16 can connect with the spout shell 12 in other conventional manners. The bottle insert 16 is generally cylindrical in configuration. An over mold 82 having annular ribs 84 surrounds and is connected with the bottle insert 16. The bottle insert 16 also includes a curved internal wall 86, which is similar in configuration to the curved internal wall 46 formed by the inner shell 32. The curved internal wall 86 defines a passage 88 that receives the tube 18 to further define the air vent passage 52. The curved internal wall 86 separates the air vent passage 52 from an oil passage 90 in the bottle insert 16. Culinary oil flows into and out of the bottle b to which the oil pourer 10 is connected through the oil passage 90 in the bottle insert 16. The oil passage 90 in the bottle insert 16 is in fluid communication with the oil filling opening 60 when the funnel section 20 is in the open position. The oil passage 90 in the bottle insert 16 is in fluid communication with oil outlet passage 40 when the funnel section 20 is in the open position and when the funnel section 20 is in the closed position.

The tube 18 is generally cylindrical in configuration; however, the tube can take other configurations. The tube 18 is hollow and further defines the air vent passage 52. The tube 18 extends downwardly from the spout shell 12 to define at least a portion of the air vent passage 52. The air vent opening 50 is open when the funnel section 20 is in the closed position, which is shown in FIG. 3, and when the funnel section 20 is in the open position, which is shown in FIGS. 1 and 2. This allows air to be displaced from the bottle b to which the oil pourer 10 is connected both when the bottle b is being filled and when oil is being poured from the bottle b. The tube 18 includes a flared lower end. In the illustrated embodiment, an end section 92 connects with the lower end of the tube 18. The end section 92 is trumpet-shaped flaring outwardly from a center line of the tube 18. When pouring culinary oil from a larger container into the bottle through the oil filling opening 50, the oil passes over the flared end section 92 and is inhibited from collecting at the lower end of the tube, which could possibly block the egress of air from the bottle b during the bottle-filling operation.

The spout shell 12 at least partially defines the oil outlet passage 40, an oil inlet passage 94, and the hole 66 connecting the oil outlet passage 40 to the oil inlet passage 94. The oil inlet passage 94 is in communication with the oil passage 90 in the bottle insert 16. The oil inlet passage 94 is formed when the collapsible funnel section 20 is in the open position. When the funnel section 20 is in the open position, the funnel section 20 is spaced from the shell inner surface 62. However, when the funnel section 20 is in the closed position, the funnel section 20 contacts the shell inner surface 62 and covers the hole 66 formed in the inner shell 32. As such, the funnel section 20 is positioned to direct oil toward the oil dispensing opening 34 during pouring and oil is precluded from exiting the oil pourer 10 through the oil filling opening 60 when the collapsible section 20 is in a closed position.

To use the oil pourer, an operator connects the oil pourer 10 to the bottle b of culinary oil, as shown in FIG. 3. The collapsible funnel section 20 of the oil pourer 10 is positioned in the open position (FIGS. 1 and 2) where the funnel section 20 and the spout shell 12 define the oil filling opening 60. Culinary oil from a larger container (not shown) can be poured into the bottle b through the oil filling opening 60 and through the oil pourer 10 when the funnel section 20 is in the open position. After the bottle b of culinary oil is filled, the collapsible funnel section 20 can be positioned in a closed position (FIG. 3) where the funnel section 20 seals against the spout shell 12, and more particularly the inner surface 62 of the spout shell, to close the oil filling opening 60. With the funnel section 20 in the closed position, culinary oil from the bottle b can be poured through the oil pourer 10 and through the oil dispensing opening 34.

As mentioned above, the air vent 50 remains open to ambient when the collapsible funnel section 20 is positioned in both the open position (FIGS. 1 and 2) and the closed position (FIG. 3). This allows air to exit the bottle b when the bottle is being filled with culinary oil. This also allows air (represented by dashed arrows in FIG. 3) to enter into the bottle b when culinary oil is being poured from the bottle (represented by solid line arrows in FIG. 3) . The tube 18 includes a flared lower end, which in the depicted embodiment is provided by way of the flared end section 92. Pouring the culinary oil from the larger container into the bottle b through the oil filling opening 60 results in the culinary oil passing over the flared lower end of the tube and directs the oil away from the lower opening of the tube 18 to facilitate the egress of air from the bottle b during filling.

An oil pourer with a movable funnel section has been described above with particularity. Modifications and alterations will occur to those upon reading and understanding the preceding detailed description. The invention, however, is not limited to only the embodiments described above. Instead, the invention is broadly defined by the appended claims and the equivalents thereof. It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An oil pourer comprising:
a spout shell being configured to be connected with an associated bottle of culinary oil; and
a collapsible funnel section connected with the spout shell and movable with respect to the spout shell between an open position and a closed position, when the funnel section is in the open position the funnel section and the spout shell define an oil filling opening, when the funnel section is in the closed position the funnel section seals against the spout shell to close the oil filling opening, and when in the closed position the funnel section is positioned to direct oil toward an oil dispensing opening when the oil pourer is tilted to pour culinary oil from the associated bottle through the oil pourer.

2. The oil pourer of claim 1, wherein the spout shell includes an outer shell and an inner shell, wherein the inner shell separates the oil filling opening from the oil dispensing opening.

3. The oil pourer of claim 2, wherein the inner shell includes a hole that leads to an oil outlet passage in the spout shell, wherein the oil outlet passage terminates at the oil dispensing opening.

4. The oil pourer of claim 3, wherein the funnel section seals against the spout shell adjacent to the hole when the funnel section is in the closed position.

5. The oil pourer of claim 2, further comprising a flexible membrane disposed between the inner shell and the outer shell, and the funnel section is integrally formed with the flexible membrane.

6. The oil pourer of claim 1, wherein the spout shell includes a shell inner surface and the funnel section includes a funnel section inner surface, wherein the shell inner surface is concave and the funnel section inner surface is concave when in the open position and convex when in the closed position.

7. The oil pourer of claim 1, wherein the funnel section includes a hinge section adjacent a substantially U-shaped edge of the spout shell, the funnel section folding about hinge section when moving from the open position toward the closed position.

8. The oil pourer of claim 7, wherein the hinge section is substantially U-shaped and follows the contour of the substantially U-shaped edge of the spout shell.

9. The oil pourer of claim 7, wherein the hinge section has a reduced thickness as compared to an adjacent portion of the funnel section.

10. The oil pourer of claim 1, further comprising a tube extending downwardly from the spout shell and defining at least a portion of an air vent passage, and the spout shell includes an air vent opening in communication with the air vent passage.

11. The oil pourer of claim 10, wherein the air vent opening is open to ambient when the funnel section is in the closed position and when the funnel section is in the open position.

12. The oil pourer of claim 10, wherein the tube includes a flared lower end.

13. A method of using an oil pourer comprising:
connecting an oil pourer to a bottle of culinary oil;
positioning a collapsible funnel section of the oil pourer in an open position where the funnel section and a spout shell connected with the funnel section define an oil filling opening;
pouring culinary from a container into the bottle through the oil filling opening and the oil pourer with the funnel section in the open position;
positioning the collapsible funnel section of the oil pourer in a closed position where the funnel section seals against the spout shell to close the oil filling opening; and
pouring culinary oil from the bottle through the oil pourer and an oil dispensing opening with the funnel section in the closed position.

14. The method of claim 13, wherein the oil pourer includes an air vent that remains open to ambient when the collapsible funnel section is positioned in both the open position and the closed position.

15. The method of claim 13, wherein pouring culinary from a container into the bottle through the oil filling opening further includes passing the poured culinary oil over a flared lower end of a tube extending away from the spout shell in the bottle of culinary oil.

16. An oil pourer comprising:
a spout shell at least partially defining an oil outlet passage, an oil inlet passage, and a hole connecting the oil outlet passage and the oil inlet passage, the spout shell being configured to be connected with an associated bottle of culinary oil;
a collapsible funnel section connected with the spout shell and movable with respect to the spout shell between an open position and a closed position, when the funnel section is in the open position the funnel section is spaced from a shell inner surface, when the funnel section is in the closed position the funnel section contacts the shell inner surface and covers the hole.

17. The oil pourer of claim 16, wherein the funnel section includes a funnel section inner surface, wherein the shell inner surface is concave and the funnel section inner surface is concave when in the open position and convex when in the closed position.

18. The oil pourer of claim 16, wherein the funnel section includes a hinge section adjacent a substantially U-shaped edge of the spout shell, the funnel section folding about hinge section when moving from the open position toward the closed position, and the hinge section is substantially U-shaped and follows the contour of the substantially U-shaped edge of the spout shell.

19. The oil pourer of claim 16, wherein the spout shell includes an outer shell and an inner shell, wherein the inner shell separates the oil outlet passage from the oil inlet passage, wherein the inner shell includes the hole, wherein the oil outlet passage terminates at an oil dispensing opening, wherein the funnel section seals against the spout shell adjacent to the hole when the funnel section is in the closed position.

20. The oil pourer of claim 16, further comprising a tube extending downwardly from the spout shell and defining at least a portion of an air vent passage, and the spout shell includes an air vent opening in communication with the air vent passage, wherein the air vent opening is open to ambient when the funnel section is in the closed position and when the funnel section is in the open position.
